(19) United States
(12) Patent Application Publication
(10) Pub. No.: US 2012/0049538 A1
(43) Pub. Date: Mar. 1, 2012

(54) SIMPLE GENERATOR

(76) Inventors: Pari kumar Periasamy, Tamil Nadu (IN); Samuel J.K Abraham, Tamilnadu (IN)

(21) Appl. No.: 12/737,653

(22) PCT Filed: Aug. 7, 2008
(86) PCT No.: PCT/IN2008/000495

§ 371 Date: Oct. 14, 2011

(51) Int. Cl. H02K 7/116

(52) U.S. Cl. 290/1 C

(57) ABSTRACT

Electricity is the vital energy that we are dependant upon. To produce electricity there are several methods. This electrical generator converts weight energy into electrical energy through a system that has a static magnet with the coil of wire that can rotate within the magnetic field. This coil is attached to the shaft with the wheel. This wheel is made to rotate by the toothed shaft which is connected to the top plate. The top plate when pressed due to mechanical weight makes the wheel rotate which in turn rotates the coil within the magnetic field, thus electricity is generated. The miniature form of this kind of electricity generators can be constructed with in the sole of the shoes, medium sized generators can be constructed at homes, and large sized generators can be constructed under the roads. With this electricity generator, every man and every vehicle can produce electricity with out expenditure & with out fuel.

### FIELD OF INVENTION

### Power Generation System at Homes, Public Places and on Roads

This invention pertains to the field of electricity generation, which will deal with the production of electric power by converting the mechanical weight energy into electricity.

### BACKGROUND OF THE INVENTION WITH REGARD TO THE EXISTING SYSTEM

It is a well known fact that electricity in generated by either a turbine, engine, water wheel or other similar machine to drive an electric generator or a device that converts mechanical or chemical energy to electricity. Steam turbines, internal combustion turbines, gas combustion turbines, water turbines and wind turbines are the most common methods to generate electricity.

A turbine converts the kinetic energy of a moving fluid, liquid or gas, to mechanical energy. Steam turbines have a series of blades mounted on a shaft against which steam is forced thus rotating the shaft connected to the generator. In a fossil fueled steam turbine, the fuel is burned in a furnace to heat water in a boiler to produce steam.

Coal, petroleum, natural gas are burned in large furnaces to heat water to make steam that in turn pushes on the blades of the turbine. Nuclear power is a method in which steam is produced by heating water through a process called nuclear fission.

Hydro power is a process in which flowing water is used to spin a turbine connected to a generator. Geothermal power, Solar power, wind power, biomass are the other alternative sources of electricity production.

This invention pertains to this field with the difference of the weight energy being converted into electrical energy. The body weight of human beings and moving vehicles are converted into mechanical and electrical energy.

The basic idea of electricity production is a coil of wire rotating with in a magnetic field. Interrupting the magnetic field produces a charge caused by the electron movement. This is called electricity. To make the coil rotate, there are different systems in the world. We here use the weight energy to make the rotation on the turbine. This requires a static magnet, with a coil of wire placed at the centre of the magnetic field. This coil is connected to the turbine. The turbine in turn is connected to a corrugated curved shaft which is attached to a large top plate on the upper aspect.

Any pressure given on the top plate will rotate the turbine and the coil rotates and electricity is generated. The plate is kept in position by the springs on either side to prevent it from touching the turbine. Once the pressure is released from the plate, the plate moves to the original place. For every pressure, the turbine is made to rotate. When this happens continuously, this mechanism works out to be the easiest way of electricity generation. To gain the mechanical advantage, a wheel may be coupled with one or more wheels which will give maximum efficiency.

If this whole system is kept at homes over the ‘Veranda’ or a common walking place, every time a man walks on the top plate, electricity is generated. At home, a walking corridor can be created with at least 100 such units. Each plate is made to be of 1 feet×1 feet size. The walking corridor could be of the size 5 feet×20 feet. So there are 100 numbers of electric generation units. Approximately if a person walks over this corridor for 30 minutes he will press at least 5000 times and thus producing approximately 6 units of electricity which will be sufficient to maintain a small house with 5 people for 2 days.

If the similar electricity generation unit is considered in a miniature size, that could be fit into the sole of a shoe, that could be used as a charger for the cell phone, hearing aid, walkman, cardiac pace maker or any other wearable electrical device.

If the similar electricity generation unit is considered in a massive size, that could be fit on the roads, every vehicle that passes on the road can give pressure on the top plate and massive quantities of electricity generation is possible. In this case the top plate may be of the size of a lorry chassis, approximately 20 ft×6 ft.

This electric production method will make every shoe, every home, every road and every public place as the power production unit.

### DETAILED DESCRIPTION

### Diagrams Enclosed

### Diagram Description

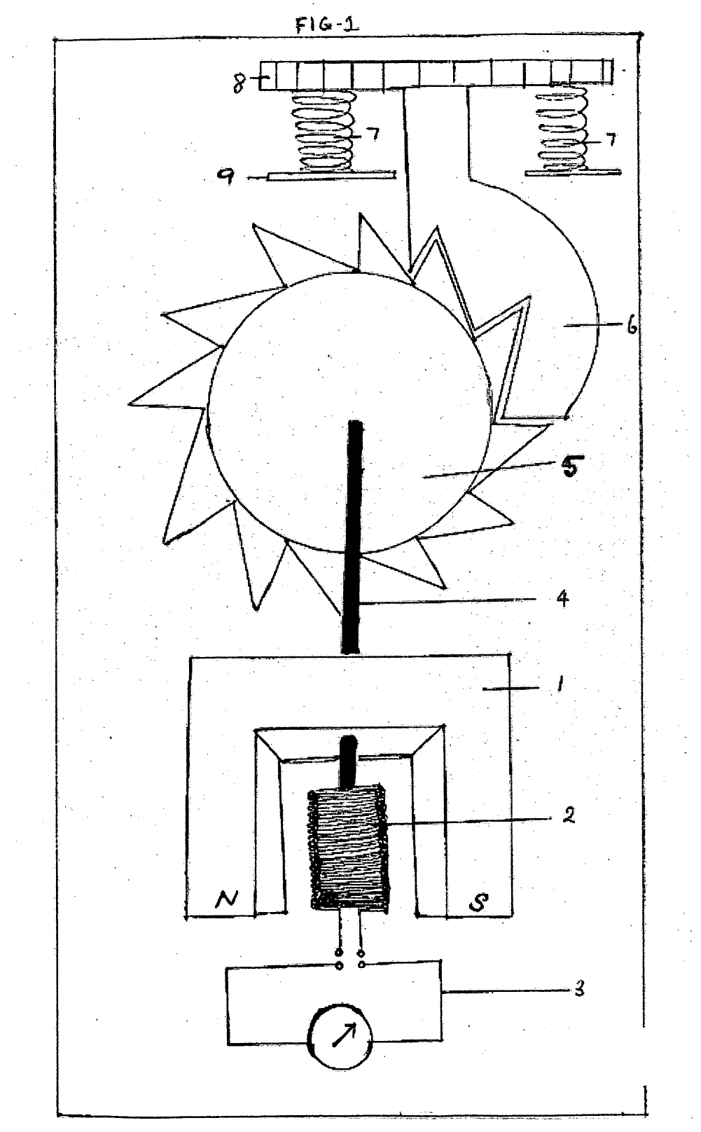

FIG. 1

1. Static Magnet.

2. Copper Coil.

3. Electric Circuit that carries the output electric power.

4. Rotating shaft

5. Wheel or Turbine with toothed edge.

6. Toothed & curved shaft.

7. Spring.

8. Top plate.

9. Support platform for the spring.

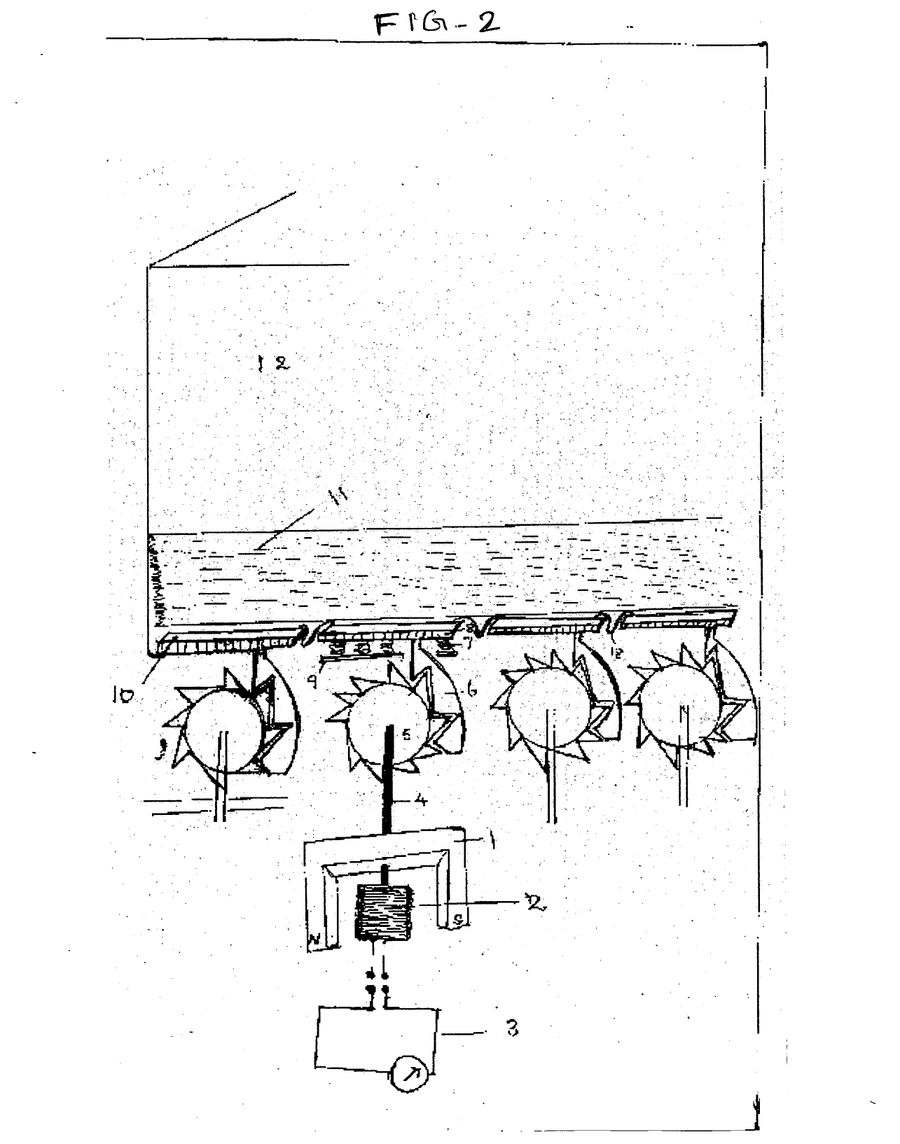

FIG. 2

10. Floor tile

11. Carpet

12. wall

18. Rubber Beading

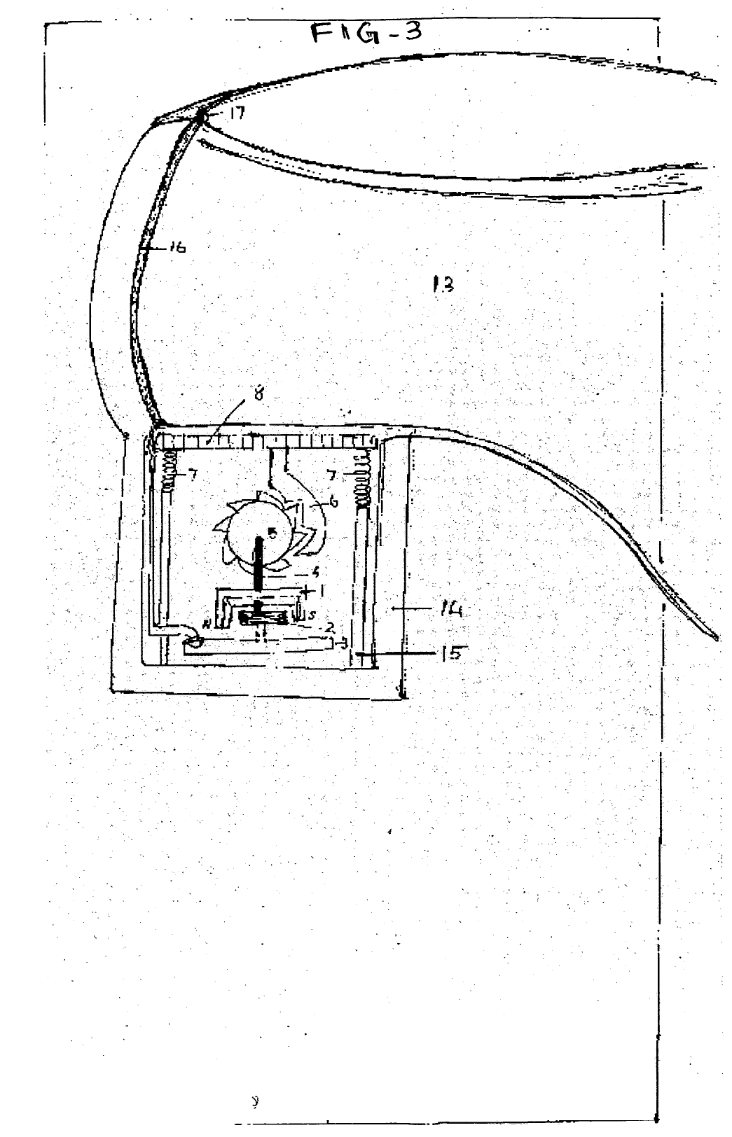

FIG. 3

13. Shoe

14. Sole of the shoe

15. Support stand for the spring.

16. Channel for the wire

17. Socket.

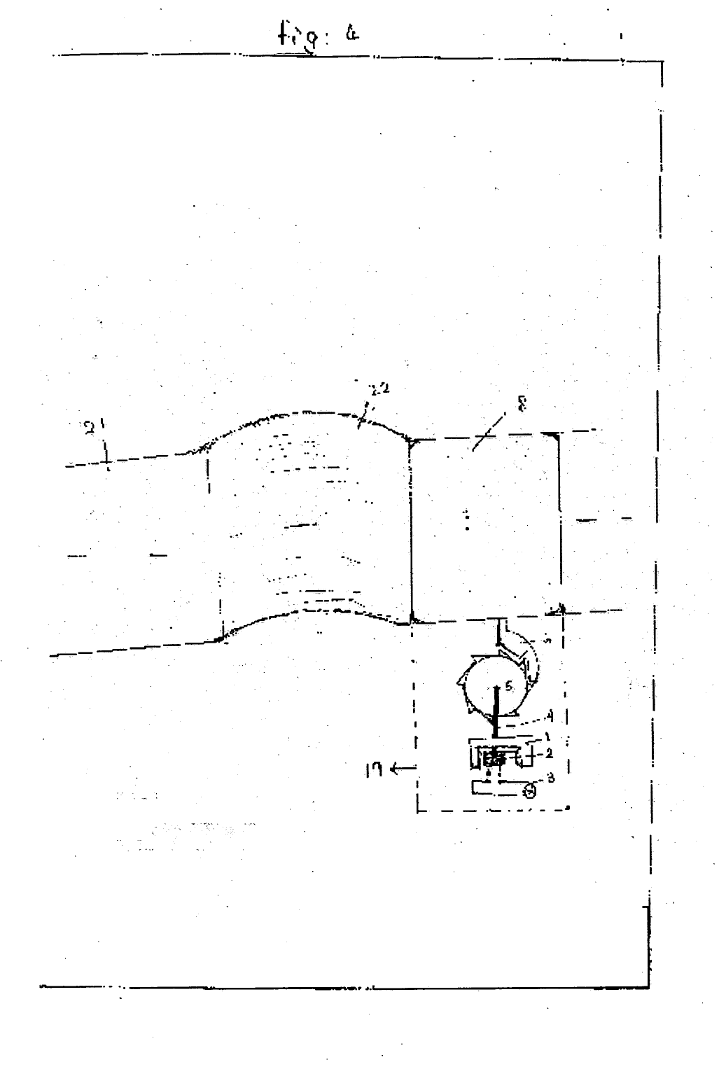

FIG. 4

The simple generator planted under the road next to a speed breaker.

19. Under ground pit.

20. Road

21. Speed Breaker Hump.

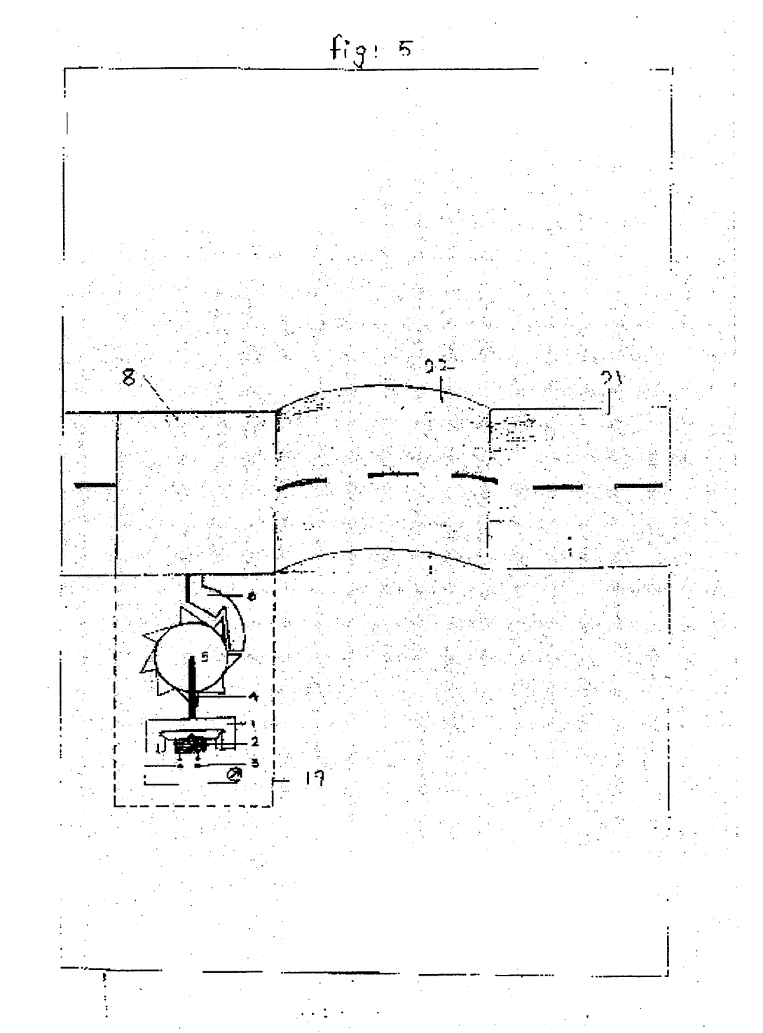

FIG. 5

The simple generator planted under the road before a speed breaker.

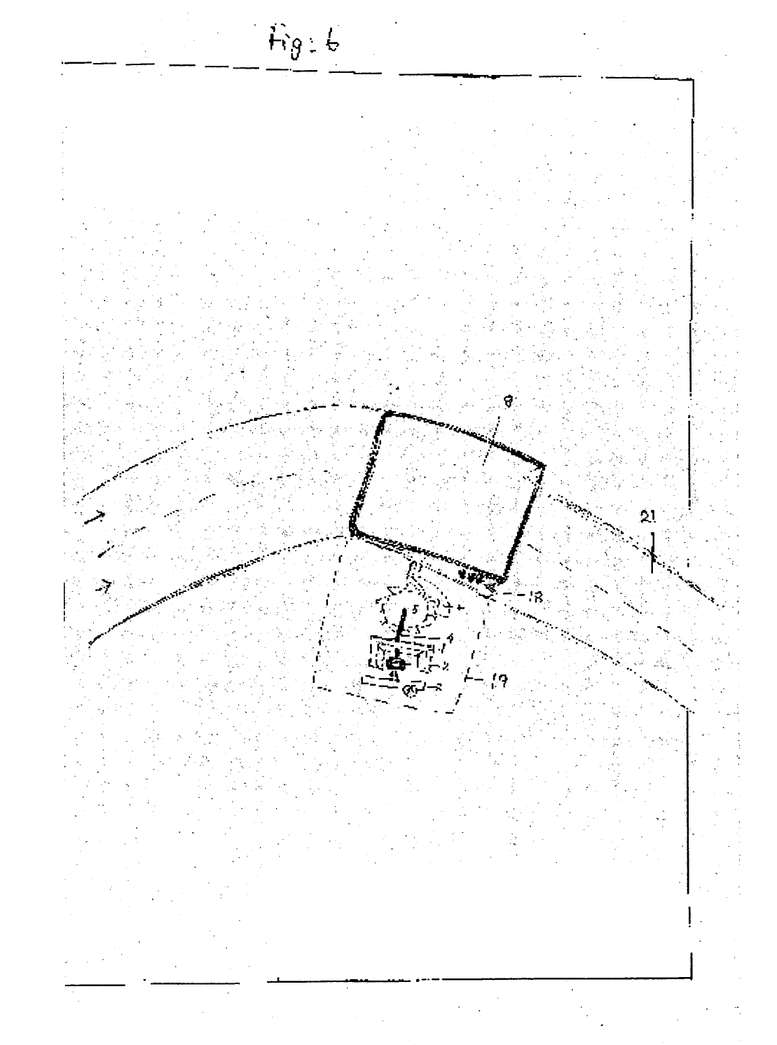

FIG. 6

The simple generator planted under the road at a sloppy part of the road.

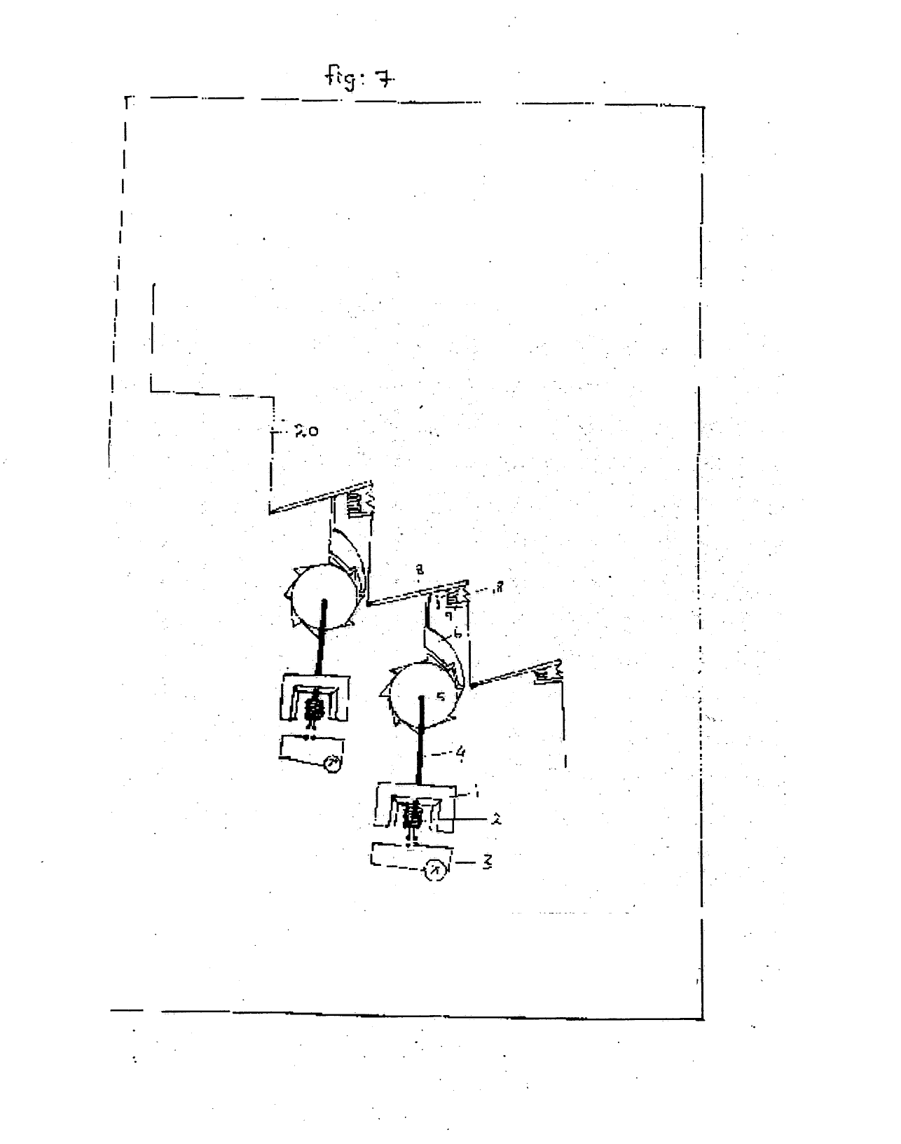

FIG. 7

The simple generator positioned under a staircase with sloppy top plate.

20. Staircase.

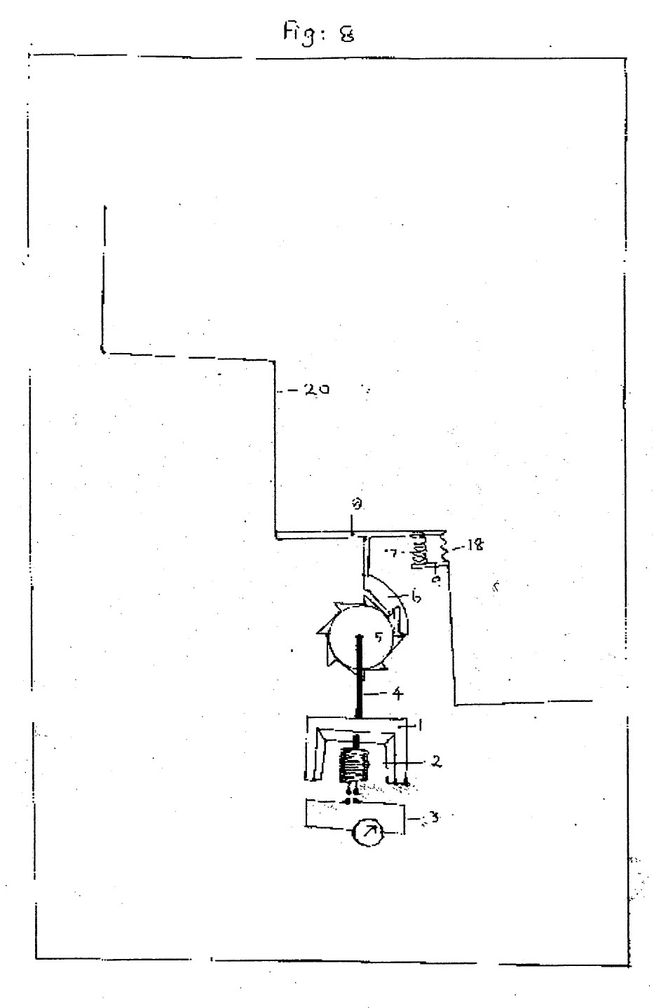

FIG. 8

The simple generator positioned under a stair case with flat top plate

In FIG. 1 the magnet 1 is a static one and having 2 arms namely North Pole and South Pole. 3 is the electric circuit that carries out the generated electricity. The shaft 4 is attached with the Copper coil. The other side of the shaft is attached with to a turbine or a wheel. This wheel 5 has a corrugated edge with teeth all around. The shaft 6 is a curved & toothed structure which extends from the top plate 8. The spring 7 is meant to be attached at the bottom of the top plate. The tooth like projection of the wheel 5 and the shaft 6 are kept facing each other so as to fix exactly, with each other. This arrangement makes the wheel 5 to rotate when the top plate 8 is pressed. The springs rest on platform 9 which are held in position from the floor.

FIG. 2 shows the electrical generator incorporated at the floor under the carpet 11. The floor tiles 10 may be of the size 1 ft×1 ft. the size of the floor tiles may vary according to convenience. The edges of the tiles may attach to the rubber beadings 18 to prevent water and dust from entering in to the generator. No: 12 is a wall of the corridor. Figure No: 3 shows how this generator in its miniature size can fit into the sole of a shoe. No: 13 represent a shoe with its sole 14. All the embodiments are similar except for the size. The size of the wheel 5 can vary from 3 mm to 5 mm. According the size of the magnet, coil, and the top plate can vary in size. The top plate 8 is designed in such a way that it rests beneath the sole sheet of the shoe. The springs rest on the rod 15 which is attached to the bottom layer of the sole. When the top plate is pressed by the heel, electricity is generated. The generated electricity is carried via the channel 16 to the output socket 17. From 17, the electricity could be carried through wires placed with in the pants covered by a cloth sleeve, which goes up to the hip. From there the electricity is supplied to the cell phone which is placed in the belt pouch. In the similar manner, power supply could be issued to the walkman, cardiac pacemaker, hearing aid etc.

The top plate 8, when pressed repeatedly keeps the wheel 5 rotating continuously which makes the coil 2 to rotate with in the magnetic field of the magnet 1. Now electric current is generated and the output voltage is received at the circuit 3. With the help of a measuring device 9, the quantity of electricity is measured and utilized as per the requirement. To prevent dust and water from entering into the generator, the floor tiles and the top plates of the road generators could be provided with rubber beadings 18 all around their edges. In this kind of electric generator, the body weight of human beings and the weight of the moving vehicles are invested usefully to produce electricity. Every home, every public place where there is human movement, every road with lot of traffic is made a power generating unit. Electricity thus produced, can be used as an additional source of electrical energy if not used as the main source. If done properly and effectively, this kind of electric generators can be made the primary source of electricity which will help the people to be independently producing their electrical needs on their own. The smallest unit of this kind can be utilized as a cell phone charger, and largest such units can be used as massive electrical generators on the national highways.

With this simple generator, every human being walking on the earth can produce electricity and every moving vehicle on earth can contribute to producing electrical energy without effort and expenditure.

Alternatively the copper coil can be made static and the magnet can be made to rotate around the copper coil. This is a walkover generator. This is not portable. If you walk over it or run a vehicle over it, this generator can produce electricity.

The drawings are not to the scale and hence the size and measurements can vary from place to place. The FIG. 3 shows the incorporated simple generator with in the sole of a shoe. The embodiments are similar to the description given in FIG. 1, except for the size and the support platform for the spring. Here, the support platform extends from the bottom of the sole of the shoe as a rod and supports the springs on either sides of the wheel and magnet. These are bilaterally similar embodiments on either sides of the wheel. The output circuit is connected to the wires at one side of the inner aspect of the sole of the shoe which goes up to the top portion of the shoes opening on one of the sides correspondingly.

FIG. 4 shows the simple generator planted under the road next to the speed breaker hump. Here the size of the wheel or the turbine may be of the size 1 Meter diameter. Relatively all the other embodiments are enlarged in size. The road 21 has the speed breaker hump 22 and the top plate 8 of the generator is planted next to the speed breaker hump.

FIG. 5 shows the speed breaker hump 22 and the simple generator is fixed before the hump under the road 21. As in FIG. 4 here also the simple generator is planted under the road with the top plate 8 corresponding to the top surface of the road 21.

FIG. 6 shows the simple generator planted under the road at a slope. The top plate 8 is corresponding to the surface of the road on the front aspect and the back aspect of the top plate is slightly elevated than the surface of the road. When the spring is pressed the back aspect of the top plate 8 will correspond to the surface of the road 21.

FIG. 7 shows the incorporation of the simple generator under the staircase 20 with the top plate 8 built as the sloppy structure and when it is pressed it will come to 180 ° position.

FIG. 8 show the simple generator incorporated under the staircase 20 so that the top plate 8 is horizontally placed at 180° and when pressed it will go down and become a downward slope.

The embodiments of the simple generator are similar structures except for the size and they are placed in multivarious places according to the need. The rubber beading 18 is incorporated in all the places under the tiles under the staircase and on the roads in close association with the top plate to prevent water and dust from entering in to the generator.

### Home Electric Generator:

At homes, these electrical generators could be constructed at the common hall or corridor where people keep walking. This walking corridor may be of the size 5 feet×20 feet, thus having approximately 100 mini generators on the corridor. The 100 top plates could be covered with the floor tiles and above that a carpet is spread, which will give a spongy soft feeling while walking over this corridor. In between the tiles there could be space that can attract dust. This could be avoided using rubber beadings. Transformers may be used to modulate the electrical energy. Thus a person having a regular walk on this walking corridor will achieve the dual purpose of exercising and producing electricity.

### Cell Phone Charger:

Man is using electrically rechargeable devices like cell phone, hearing aid, walkman, cardiac pace makers etc. All these devices need electrical energy for a continuous use. So, by constructing this kind of small electrical generators in the sole of the shoes, one can produce electricity while walking. Spontaneously while walking the batteries of their electrical devices get charged which does not require any additional power supply. This makes life very simple and independent.

### Massive Generators:

Every national high way allows the passage of at least 10,000 vehicles per day approximately. If each heavy vehicle with tons of load, presses this electrical generator constructed on the roads, they will produce huge quantities of electricity in several kilowatts to megawatts. For every generator, we have to spend money on the fuel. Making use of coal, gas, steam is all very expensive. Constructing thermal power station, nuclear power stations and hydro power stations are very expensive projects. But this fuel free electric generators could be built with a minimum expenditure comparatively.

### Advantages

The major advantages with this simple generator are
i) It is very simple to construct
ii) No fuel required
iii) No fumes & no pollution
iv) No threat to the environment and does not contribute to the global warming.
v) Maintenance free electrical generator.
vi) Uses range from cell phone to factories.
vii) Range of electricity power production can vary from few Volts to Mega Watts.

It will be appreciated by those skilled in art of having the benefit of this disclosure that this invention provides a simple generator. It should be understood that the drawings and detailed description herein are to be regarded in an illustrative rather than a restrictive manner, and are not intended to limit the invention to the particular forms and examples disclosed. On the contrary, the invention includes any further modifications, changes rearrangements, substitution, alternatives, design choices and embodiments apparent to those of ordinary skill in the art without departing from the spirit and scope of this invention as defined by the following claims. Thus, it is intended that the following claims be interpreted to embrace all such further modification, changes, rearrangements, substitutions, alternatives, design choices and embodiments.

We claim:

1) An electric power generator with magnet and copper coil which can rotate within the magnetic field and the rotation is provided by the rotation of a toothed wheel, which in turn is made to rotate by the pressure exerted on it from the top plate by the mechanical weight of human beings and moving vehicles.

2) An electric generator according to claim 1 with a connecting shaft between the copper coil and the wheel:

3) An electric generator, according to claim 1 a toothed and curved shaft, that can fix over the teeth of the wheel.

4) An electric generator, according to claim 3, a toothed and curved shaft with a curved body and a straight shaft to get attached to the top plate.

5) An electric generator according to claim 1, having springs on either sides of the curved and toothed shaft near its attachment to the top plate.

6) An electrical generator according to claim 5, having a supportive platform for the springs to rest.

7) An electrical generator, according to claim 5, having the upper end of the springs attached to the bottom of the top plate and having the lower end of the springs attached to the top of the supporting platforms.

8) An electrical generator according to claim 1, having the top plate freely presses able because of the springs.

9) An electrical generator according to claim 1, having an electrical circuit connected to the rear end of the copper coil system.

10) An electrical generator according to claim 9, having a measuring device connected to the out put circuit.

11) An electrical generator according to claim 1, having a top plate springs curved toothed shaft, a wheel, a rod connected to the centre of the wheel, a copper coil, a magnet and the electrical output circuit, fitted with in the sole of a shoe, with output wires going within the shoes, within the pants and then into the cellphone, hearing aid, cardiac pace makers or walkman, which when the top plate is pressed by the heal of the walking man wearing this shoe will produce electricity.
i) Having a pair of supporting platforms attached to the lower wall of the sole of the shoe.
ii) Having springs on top of the supporting platforms.
iii) Having the top plate sitting over the springs.
iv) Having the output circuit connected to the output wire.

12) According to claim 11, an electric generator, having a channel for the output pair of wires on the inner aspect of the back of the shoe.

13) According to claim 11, and electric generator, having a socket at the top surface of the edge of the shoe at the rear portion.

14) According to claim 11, an electric generator having a conducting wires, sheathed with a cloth sleeve extending from the bottom of the pants to the top of the pants through one of the inner aspect of the pants.

15) According to claim 11, an electric generator having a cloth sleeve containing the output pair of wires with in the shirt or tops to reach the walkman, hearing aid or cardiac pace maker.

16) An electrical generator according to claim 1, having the top plate, toothed and curved shaft, springs, wheel or turbine, shaft connecting the wheel with the copper coil, magnet, and output wiring system, all placed under the road, having the top plate at the level of the road, which when the top plate is pressed by the moving vehicle will produce electricity.
i) Having rubber beadings around the top plate to prevent water & dust from getting in to the generator.

17) An Electrical generator according to claim 1, having the top plate, toothed and curved shaft, springs, wheel, shaft connecting the wheel with the copper coil, magnet, an output wiring system, all placed under the floor of the house, having the top plate just beneath the floor tiles, over which a carpet is placed, which when the top plate is pressed by the walking man will produce electricity.
i) Having a rubber beading, around the top edge of the top plate connected to the floor tiles, to prevent water and dust getting into the generator.

18) According to claim 11, an electric generator, having the top plates with a size of 5 cm×5 cm, the wheel with a size of 3 mm to 5 mm.

19) According to claim 16, an electric generator having the top plate with a size of 20 ft×6ft and the turbine having a size of 1 meter diameter.

20) According to claim 17, an electric generator having the top plate with a size of 1 ft×1 ft. and the wheel with a size of 15 cms diameter
